(19) United States
(12) Patent Application Publication
(10) Pub. No.: US 2023/0334866 A1
(43) Pub. Date: Oct. 19, 2023

(54) Remote Vehicle Inspection

(71) Applicant: Tractable Ltd, London (GB)

(72) Inventors: Franziska KIRSCHNER, London (GB); Yih Kai TEH, London (GB)

(21) Appl. No.: 17/659,681

(22) Filed: Apr. 19, 2022

(51) Int. Cl. G06V 20/40; G07C 5/08; G07C 5/00

(52) U.S. Cl. CPC G06V 20/46; G06V 20/41; G06V 20/48; G07C 5/0825; G07C 5/008

(57) ABSTRACT

A method for inspecting a vehicle, comprising capturing one or more segments of video of the vehicle comprising a plurality of parts, identifying, using one or more classifiers, one or more parts of the vehicle captured in the one or more segments of video, generating feedback related to capturing the one or more segments of video and displaying an interface comprising the feedback and video data being captured.

### BACKGROUND

An artificial intelligence (AI) system may perform a rapid inspection of a vehicle by utilizing computer vision and other machine learning techniques to autonomously assess the state of the vehicle. An entity may release a user facing application that uses this type of AI system to provide any of a variety of different types of services. To provide an example, the state of the vehicle may be evaluated by the AI system to produce an estimated repair cost without involving a professional claims adjuster. In another example, the state of the vehicle may be evaluated by the AI system to appraise the vehicle on behalf of an online used car retailer without involving a professional appraiser.

The user may record a video of the vehicle using their mobile device. The video may be input into the AI system to assess the state of the vehicle. However, if the video does not adequately capture the vehicle and/or the video is not of sufficient quality, the AI system may be unable to assess the state of the vehicle. In this type of scenario, the user may be requested to provide additional video.

The user experience associated with the application is an important factor in attracting and retaining users. Each interaction between the user and the application is a potential point of friction that may dissuade a user from completing the inspection process and/or utilizing the application in the future. For example, the user may decide to not utilize the application if it is inconvenient or difficult for the user to record the video content that is to be used by the AI system to assess the state of the vehicle. Accordingly, there is a need for mechanisms that are configured to collect adequate data for the AI system to assess the state of the vehicle without negatively impacting the user experience associated with the application.

### SUMMARY

Some exemplary embodiments are related to a method for inspecting a vehicle. The method includes capturing one or more segments of video of the vehicle comprising a plurality of parts, identifying, using one or more classifiers, one or more parts of the vehicle captured in the one or more segments of video, generating feedback related to capturing the one or more segments of video and displaying an interface comprising the feedback and video data being captured.

Other exemplary embodiments are related to a computer program product for inspecting a vehicle including computer code to capture one or more segments of video of the vehicle comprising a plurality of parts, identify, using one or more classifiers, one or more parts of the vehicle captured in the one or more segments of video, generate feedback related to capturing the one or more segments of video and display an interface comprising the feedback and video data being captured.

### BRIEF DESCRIPTION OF THE DRAWINGS

FIG. 1 shows an exemplary user device according to various exemplary embodiments.

FIG. 2 shows an exemplary system according to various exemplary embodiments.

FIG. 3 shows a method for performing a real-time inspection using an artificial intelligence (AI) based application to assess a state of a vehicle according to various exemplary embodiments.

FIGS. 4a-4b show exemplary dynamic overlays for tracking the user's progress of recording video that adequately captures the vehicle according to various exemplary embodiments.

FIG. 5 shows a method for determining a value of an inspected vehicle according to various exemplary embodiments.

### DETAILED DESCRIPTION

The exemplary embodiments may be further understood with reference to the following description and the related appended drawings, wherein like elements are provided with the same reference numerals. The exemplary embodiments introduce systems and methods for performing a real-time inspection of a vehicle using artificial intelligence (AI). As will be described in more detail below, computer vision and other types of machine learning techniques may be used on data collected by a user device to autonomously assess the state of the vehicle.

The exemplary embodiments are described with regard to an application running on a user device. However, reference to the term “user device” is merely provided for illustrative purposes. The exemplary embodiments may be used with any electronic component that is configured with the hardware, software and/or firmware to communicate with a network and collect video of the vehicle, e.g., mobile phones, tablet computers, smartphones, etc. Therefore, the user device as described herein is used to represent any suitable electronic device.

Furthermore, throughout this description, it may be described that certain operations are performed by “one or more classifiers.” It should be understood that any reference to one or more classifiers may refer to a single classifier or a group of classifiers. In addition, it should also be understood that the “one or more classifiers” described as performing different operations may be the same classifiers or different classifiers. As will be described in more detail below, in some exemplary embodiments, some or all of the operations may be performed by a user device. In some exemplary embodiments related to the user device (or any other type of device), a single classifier may perform all the operations described herein.

In addition, the exemplary embodiments are described with reference to a vehicle and capturing images or video of the vehicle for the purpose of assessing the state of the vehicle. It should be understood that the exemplary embodiments are not limited to assessing a state of a vehicle. The exemplary embodiments may be implemented for any item for which a value or a condition may be evaluated. To provide some non-limiting examples, houses, buildings, boats, planes, valuables (jewelry, art, etc.), etc.

In some exemplary embodiments, it may be described that the AI may make evaluations by comparing images of a damaged vehicle versus images of undamaged vehicles. However, it should be understood that the exemplary embodiments do not require such a comparison. In other exemplary embodiments, the AI may make evaluations without directly comparing an image of a damaged vehicle with images of undamaged vehicles. That is, the classifiers described herein may perform property evaluations for damaged vehicles without regard to images of undamaged vehicles.

An entity may release an application that utilizes AI to assess the state of the vehicle to provide any of a variety of different services. To provide an example, the state of the vehicle may be evaluated by the AI system to produce an estimated repair cost without involving a professional claims adjuster. In another example, the state of the vehicle may be evaluated by the AI system to appraise the vehicle and produce an initial estimate on behalf of an online used car retailer without involving a professional appraiser. However, the exemplary embodiments are not limited to the example use cases referenced above. The exemplary techniques described herein may be used in independently from one another, in conjunction with currently implemented AI systems, in conjunction with future implementations of AI systems or independently from other AI systems.

The user may record a video of the vehicle using their user device. However, if the video does not adequately capture the vehicle and/or the video is not of sufficient quality, the AI system may be unable to assess the state of the vehicle from the video data. In this type of scenario, the user may be requested to provide additional video. To ensure an adequate user experience, the process of collecting the video from the user should be an easy task for the user to complete.

The exemplary mechanisms described herein may reduce friction and improve the user experience associated with the application. For instance, in some examples, the user device may be configured to provide dynamic feedback to the user during the recording of the video to guide the user in capturing video that adequately captures the vehicle and/or is of sufficient quality to assess the state of the vehicle. The dynamic feedback makes the process of recording the video more intuitive and/or user-friendly. However, this is just one example of the various types of functionalities that may be enabled by the exemplary mechanisms introduced herein.

According to some aspects, one or more classifiers may be executed at the user device. For example, a classifier may be used to determine which one or more parts of the vehicle are shown in the video. In another example, a classifier may be used to determine different types of damage present on the vehicle or to determine the locations of the damage. In addition, the one or more classifiers may also identify the locations of parts on a vehicle. In some embodiments, this may further include assessing a degree or magnitude of damage, identifying repair operations that may be performed to improve the state of the vehicle and identifying parts that may be replaced to improve the state of the vehicle. The user device may produce the assessment of the state of the vehicle in real-time. That is, the assessment may be executed at the user device using one or more classifiers and/or any other appropriate type of AI techniques. This is in contrast to a system that relies on a remote server to process the video and perform the assessment of the state of the vehicle.

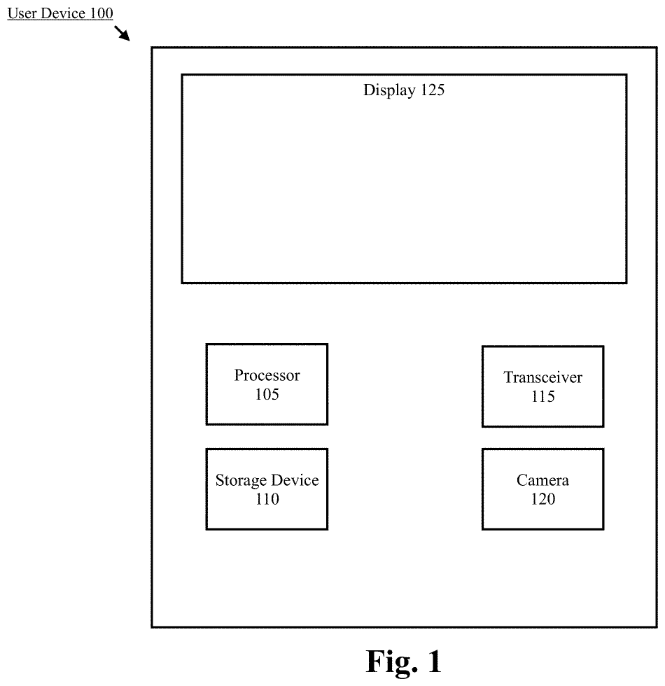

FIG. 1 shows an exemplary user device 100 according to various exemplary embodiments described herein. The user device 100 includes a processor 105 for executing the AI based application. The AI based application may be, in one embodiment, a web-based application hosted on a server and accessed over a network (e.g., a radio access network, a wireless location area network (WLAN), etc.) via a transceiver 115 or some other communications interface.

The above referenced application being executed by the processor 105 is only exemplary. The functionality associated with the application may also be represented as a separate incorporated component of the user device 100 or may be a modular component coupled to the user device 100, e.g., an integrated circuit with or without firmware. For example, the integrated circuit may include input circuitry to receive signals and processing circuitry to process the signals and other information. The AI based application may also be embodied as one application or multiple separate applications. In addition, in some user devices, the functionality described for the processor 105 is split among two or more processors such as a baseband processor and an applications processor. The exemplary embodiments may be implemented in any of these or other configurations of a user device.

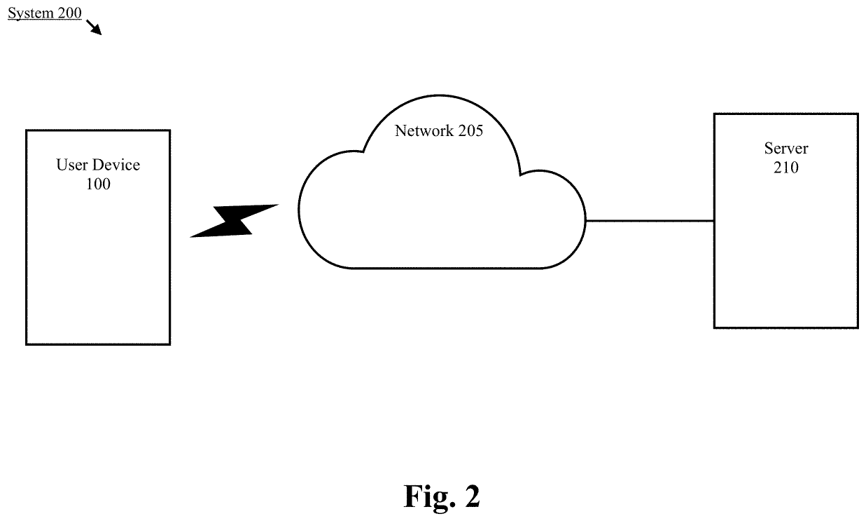

FIG. 2 shows an exemplary system 200 according to various exemplary embodiments. The system 200 includes the user device 100 in communication with a server 210 via a network 205. However, the exemplary embodiments are not limited to this type of arrangement. Reference to a single server 210 is merely provided for illustrative purposes, the exemplary embodiments may utilize any appropriate number of servers equipped with any appropriate number of processors. In addition, those skilled in the art will understand that some or all of the functionality described herein for the server 210 may be performed by one or more processors of a cloud network.

The server 210 may host the AI-based application that is executed at the user device 100. However, the user device 100 may store some or all of the application software at a storage device 110 of the user device 100. For example, in some web-based applications, a user device 100 may store all or a part of the application software locally at the user device 100. The application running on the user device 100 may perform some operations and other operations may be performed at the remote server, e.g., server 210. However, there is a tradeoff between the amount of storage that may be taken up by the application at the user device 100, a reliance on connectivity to the Internet (or any other appropriate type of data network) to perform certain tasks and the amount of time that may be required to produce a result (e.g., an assessment of the state of the vehicle). Each of these aspects should be considered to ensure an adequate user experience. As described above, in some exemplary embodiments, the user device 100 may include a single classifier that performs all the operations related to the data capture aspects of the inspection, e.g., guiding the user through video and/or still photography capture.

The user device 100 further includes a camera 120 for capturing video and a display 125 for displaying the application interface and/or the video with a dynamic overlay. Additional details regarding the dynamic overlay are provided below. The user device 100 may be any device that has the hardware and/or software to perform the functions described herein. In one example, the user device 100 may be a smartphone with the camera 120 located on a side (e.g., back) of the user device 100 opposite the side (e.g., front) on which the display 125 is located. The display 125 may be, for example, a touch screen for receiving user inputs in addition to displaying the images and/or other information via the web-based application.

The exemplary embodiments may allow a user to perform an inspection of a vehicle in real-time using the user device 110. As will be described in more detail below, the user may record one or more videos that are to be used to assess the state of the vehicle. The application may include one or more classifiers for determining which parts of the vehicle have been captured in the video recorded by the user. The one or more classifiers may be executed at the user device 100 during the recording of the video. This may allow the application to provide dynamic feedback indicating to the user which parts of the vehicle have already been captured in the video, in substantially real-time. Thus, the application may provide a user interface that identifies what is currently being captured in the video and an overlay which is updated to track the user's progress as more parts of the vehicle are captured during the recording of the video. Examples of the dynamic feedback that may be provided to the user are described in more detail below.

In one example use case, the application may be used to provide an initial appraisal for an online used car retailer without involving a professional appraiser. Compared to a damage estimate for an insurance claim, an accurate appraisal may need to consider damage of a lesser magnitude and other less visually obvious factors. For example, the vehicle being inspected may not have been in a collision and thus, the video of the vehicle would not show a point of impact or damage consistent with a collision, e.g., a smashed or dented side panel, etc. However, factors such as, but not limited to, rust, paint condition (e.g., faded, peeling, flaking, bubbling, etc.) and surface condition may have an impact on the appraisal of the vehicle. It has been identified that, compared to static images, the use of one or more segments of video may substantially improve the one or more classifiers' ability to identify damage and wear to the vehicle. Thus, compared to systems that only rely on static images, the video data allows the application to identify damage of a lesser magnitude and evaluate less obvious factors when assessing the state of the vehicle. While video data provides benefits to the use case of performing an initial appraisal of the vehicle, the exemplary embodiments are not limited to this type of use case and may be utilized for any appropriate purpose.

In the example of FIG. 2, it is shown that there may be an interaction between the user device 100 and the server 210. However, it should be understood that information from the user device 100 and/or server 210 may be distributed to other components via the network 205 or any other network. These other components may be components of the entity that operates the server 210 or may be components operated by third parties. To provide a specific example, an owner of a vehicle may perform the vehicle inspection using the user device 100. The server 210 may have pre-provisioned the user device 100 with the necessary software to perform the inspection and/or may aid the owner through the inspection (e.g., by providing specific guidance as will be described in greater detail below). The results of the vehicle inspection may then be sent to a third party such as an entity that is considering buying the vehicle from the owner.

Throughout this description, the example of a vehicle inspection for the purposes of the owner selling the vehicle is described. However, there may be many other uses for the inspection results. For example, the results may be used to estimate repair cost without involving a professional claims adjuster, evaluate a returned rental car, evaluate a leased vehicle return, insurance underwriting, etc. Thus, other examples of third parties that may be interested in receiving the results of the inspection may include insurance companies, vehicle rating companies, repair shops, dealerships, leasing companies, rental car companies, etc. Thus, the results of the inspection may be made available to any entity that is authorized by the owner and/or the operator of the server 210 to receive the results.

The examples provided below reference one or more classifiers performing operations such as, but not limited to, identifying parts of the vehicle captured in one or more segments of video, identifying damage to one or more parts of the vehicle, identifying rust on one or more parts of the vehicle, determining a paint condition for one or more parts of the vehicle, identifying areas of the vehicle that require additional evidence to fully assess the condition (e.g. locations with small or difficult to see damage), identifying the vehicle itself via visual identification of the Vehicle Identification Number (VIN) text, odometer, make model year (MMY)/trim, license plate, confirming the identity of the vehicle by cross-referencing these properties, identifying part options present on a vehicle (e.g., bumper with fog lamps) because the presence of options may have a material impact on the value of the vehicle, etc. Each classifier may be comprised of one or more trained models.

The classifying AI may be based on the use of one or more of: a non-linear hierarchical algorithm, a neural network, a convolutional neural network, a recurrent neural network, a long short-term memory network, a multi-dimensional convolutional network, a memory network, a fully convolutional network, a transformer network or a gated recurrent network.

In some embodiments, the one or more classifiers may be stored locally at the user device 100. This may allow the application to produce quick results even when the user device 100 does not have an available connection to the Internet (or any other appropriate type of data network). In one example, only a single classifier is stored locally at the user device 100. This single classifier may be trained to identify all parts of the vehicle and handle all forms of biases at the same time. The use of a single classifier trained to perform multiple tasks may be beneficial to the user device 100 because it may take up significantly less storage space compared to multiple classifiers that are each specific to different parts of the vehicle. Thus, classifying AI described herein is sufficiently compact to run on the user device 100, and may include multi-task learning so that one classifier and/or model may perform multiple tasks. In previous systems, for example, a dedicated classifier may be used for each part of the vehicle (e.g., determine whether the windshield is shown in the image, whether the hood is shown in the image, etc.). However, it may not be feasible to run this AI architecture on the user device 100 due to the limited storage capacity of the user device 100 and the processing burden involved.

Generally, classifiers may be designed to progressively learn as more data is received and processed. Thus, the exemplary application described herein may periodically send its results to a centralized server so as to refine the model for future assessment.

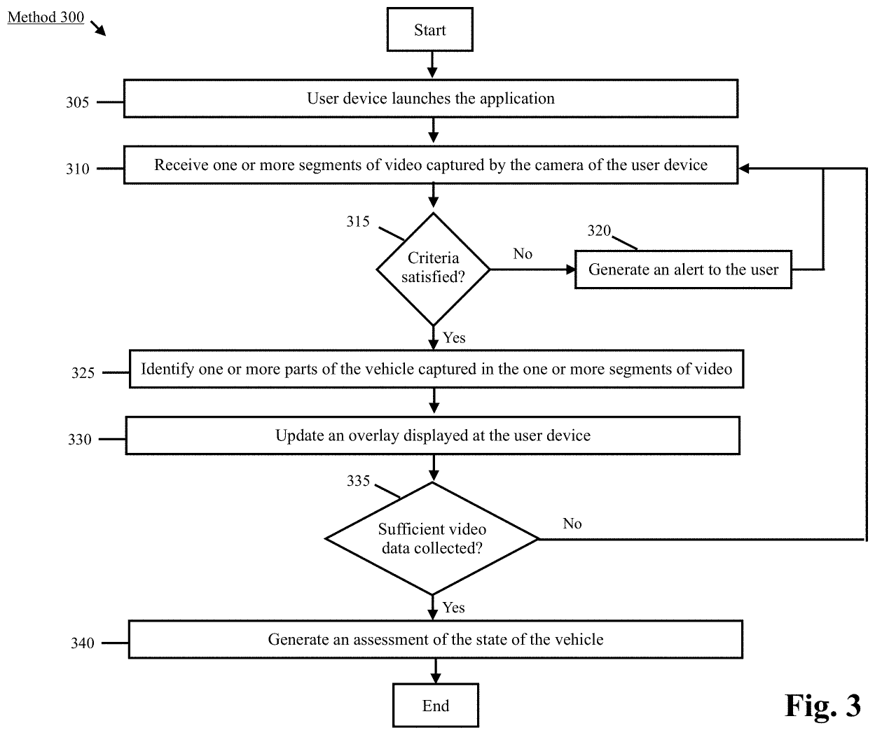

FIG. 3 shows a method 300 for performing a real-time inspection using an AI based application to assess a state of a vehicle according to various exemplary embodiments. The method 300 is described with regard to the user device 100 of FIG. 1 and the system 200 of FIG. 2.

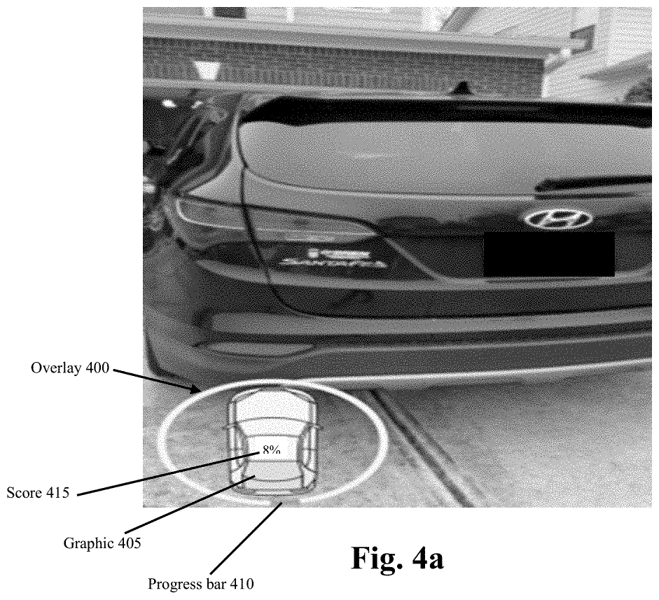

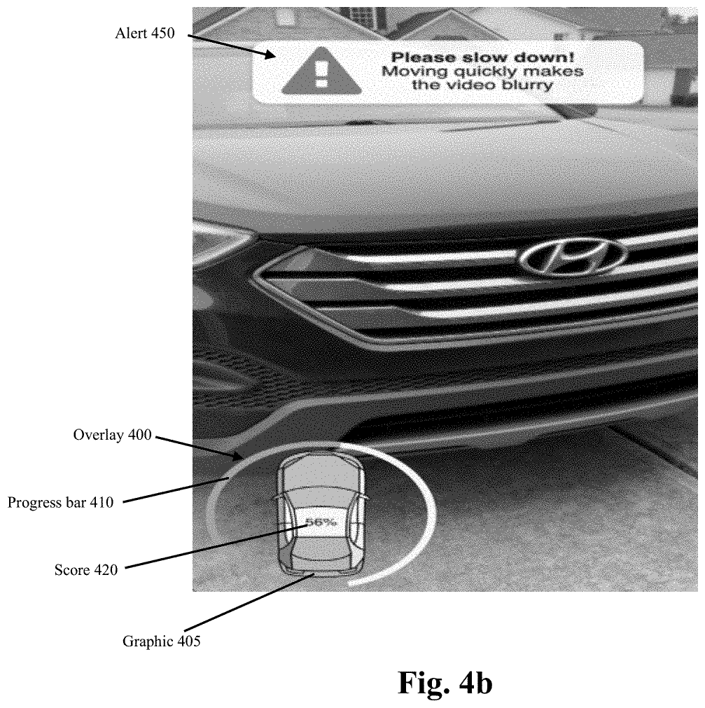

The following description of the method 300 will provide an overview of how the application may process video data, interact with the user and generate an assessment of the state of the vehicle. During the description of the method 300, examples of the dynamic feedback that may be provided to the user during the recording of the video are described below with regard to FIGS. 4a-4b.

In 305, the user device 100 launches the application. For example, the user may select an icon for the application shown on the display 125 of the user device 100. After launch, the user may interact with the application via the user device 100. To provide a general example of a conventional interaction, the user may be presented with a graphical user interface that offers any of a variety of different interactive features. The user may select one of the features shown on the display 125 via user input entered at the display 125 of the user device 100. In response, the application may provide a new page that includes further information and/or interactive features. Accordingly, the user may move through the application by interacting with these features and/or transitioning between different application pages.

In 310, the application receives one or more segments of video captured by the camera 120 of the user device 100. Throughout this description, a segment of video may generally refer to video data comprising multiple consecutive frames. The one or more segments may be part of a single recording or multiple different video recordings. In addition, the captured video may be augmented by individual frames or images separately captured at a potential higher resolution, or utilizing a different, or no, compression algorithm. These additional images may be taken at specific angles with respect to the vehicle, on a timed basis, or based on the identification of regions of particular interest.

The application may request that the user capture video of different portions of the vehicle. For example, the user may be prompted to record video of the exterior of the vehicle, the interior of the vehicle, underneath the hood of the vehicle, the undercarriage of the vehicle and/or inside the trunk. According to some exemplary embodiments, the method 300 may be a continuous process where one or more segments of video are provided downstream to the one or more classifiers while the user is actively recording video of the vehicle. This may allow the application to provide dynamic feedback that guides the user in recording video of sufficient quality for performing the assessment of the vehicle.

In 315, the application determines whether the one or more segments of video satisfy predetermined criteria. The predetermined criteria may be based on the video quality of the one or more video segments. In some embodiments, the predetermined criteria may be based on data collected from other components of the user device 100.

Some examples of insufficient video quality may include the application identifying that the one or more video segments are blurry, lack sufficient clarity, have regions experiencing glare, or have insufficient lighting. The exemplary embodiments may evaluate any appropriate type of video quality metric associated with the one or more video segments to determine whether the one or more video segments lack sufficient clarity. The video clarity may be affected by the manner in which the video is recorded. For instance, if the camera 120 moves in a particular manner during the recording of the one or more segments of video, the content may become too blurry, and it may be difficult to identify the objects captured in the video. In some embodiments, instead of or in addition to a video quality metric, the predetermined criteria may be based on a speed parameter of the user device 100, an acceleration parameter of the user device 100 and/or any other appropriate type of movement-based parameter of the user device 100 exceeding a threshold value. This may include the application collecting data from other internal components of the user device 100 (e.g., accelerometer, gyroscope, motion sensor, etc.) to derive a parameter associated with the movement of the user device 100 while recording the one or more video segments and comparing the parameter to a threshold value. If the parameter exceeds the threshold value, the application may assume that the one or more segments of video are not of sufficient quality because they were not recorded in a manner that is likely to provide video data that may be used to assess the state of the vehicle.

In another example, the application may identify that the one or more video segments were recorded from a perspective that is too close to the vehicle, too far from the vehicle and/or at an inadequate camera angle. The exemplary embodiments may evaluate any appropriate type of video quality metric associated with the one or more video segments to determine whether the one or more video segments are recorded from an appropriate perspective (e.g., distance, angle, etc.). In some embodiments, instead of or in addition to a video quality metric, the predetermined criteria may be based on a distance parameter and/or a camera angle parameter between the vehicle and the user device 100 during the recording of the one or more segments of video.

If the predetermined criteria are not satisfied, the method 300 continues to 320. In 320, the application may generate an alert to indicate to the user that the manner in which the video is being recorded needs to be modified. For example, when the application identifies that the one or more video segments lack sufficient clarity, the alert may explicitly or implicitly indicate to the user that the camera is moving too fast, and the user should slow down and/or move the camera in a less erratic manner. In another example, when the application identifies that the one or more video segments were recorded from inadequate distance or angle, the alert may explicitly or implicitly indicate to the user that the camera is too close to the vehicle, too far from the vehicle or placed at an improper angle. The alerts may be a visual alert provided on the display 125 of the user device 100 and/or audio alert provided by an audio output device of the user device 100. Additional details regarding how the alert may be provided to the user are provided in detail below with regard to FIG. 4b.

Returning to 315, if the one or more segments of video satisfy the predetermined criteria, the method 300 continues to 325. In 325, the application identifies one or more parts of the vehicle captured in the one or more segments of video. In 330, the application updates an overlay displayed at the user device 100. From the perspective of the user, the display 125 may show an interface that include the overlay and video data being captured by the camera 120. As will be described in more detail below, the overlay may be updated to indicate a position of the user device 100 relative to the vehicle during the recording, indicate an amount of video data collected and/or to be collected for the assessment of the state of the vehicle or provide any other type of information that may guide the user in recording the video needed to assess the state of the vehicle.

Additionally, the application may display information indicative of a need for a closer image of an area of potential interest. Areas of potential interest include areas of potential damage, potential inclusion of an optional part, such as one installed by an auto dealer, or a modification to a vehicle by a prior owner. The video display can dynamically indicate the area of interest using a bounding box, cross-hair, arrows, or any other visual means to indicate. Once the area of interest has been captured, a visual, audio, or haptic response can be used to indicate that the user can proceed further with the video as normal. The capture of the region of interest can include video or still images alone, or in combination. The video or still images can be at a different resolution or utilize different compression methods than the videos of the remainder of the vehicle.

As mentioned above, the application may provide dynamic feedback to the user to aid the user in recording video that adequately captures the vehicle and/or is of sufficient quality to assess the state of the vehicle. One example of dynamic feedback is the alert generated in 320. Another example of dynamic feedback is the dynamic overlay referenced in 330.

FIGS. 4a-4b show exemplary dynamic overlays for tracking the user's progress of recording video that adequately captures the vehicle according to various exemplary embodiments. FIG. 4a shows an exemplary dynamic overlay 400 displayed over a frame of a video being recorded by the user via the user device 100.

The application may request that the user record the exterior of the vehicle from multiple different perspectives. In this example, the overlay 400 may include a progress bar 410 that tracks the camera 120 position relative to the vehicle and a score 415 indicating how much of the exterior of the vehicle has been captured in the video data collected thus far. In this example, the score is shown as a percentage, however, the exemplary embodiments may utilize any appropriate quantitative value. Here, the user is positioned at the rear of the vehicle and the parts of the vehicle captured in the video recorded thus far may include, but are not limited to, a rear windshield, a rear bumper, break lights, reverse lights and rear quarter panels.

The dynamic overlay 400 includes a diagram of a vehicle in two dimensions. The two-dimensional graphic 405 is representative of a top view of the vehicle, with the sides, front and back of the vehicle unfolded outward relative to the center of the vehicle to show the aspects of the vehicle that would not typically be visible from a view above the vehicle. The two-dimensional graphic 405 is divided into sections, each section relating to one or more parts of the vehicle. For example, the graphic 405 includes sections relating to a hood, doors, a trunk, taillights, etc. In an alternative embodiment, additional portions of the vehicle may be shown in the graphic 405, such as e.g., tires, etc. The graphic 405 generally shows parts of a generic vehicle that are identifiable by the one or more classifiers of the application.

In the example of FIG. 4a, the color (or appearance) of portion of the graphic 405 may change to indicate which parts of the vehicle have been adequately captured in the video data. For instance, in some scenarios, the application may request a continuous recording with full 360-degree views of the vehicle. When a particular part of the car is identified in the one or more segments of video, the two-dimensional graphic 405 may utilize a first color to indicate which parts of the vehicle have been captured and a second different color to indicate which part of the vehicle has not yet been captured in the video data.

FIG. 4b shows the overlay 400 and the graphic 405 after additional video has been recorded relative to the frame and progress shown in FIG. 4a. In this example, the progress bar 410 has been updated to indicate that the user is now located at the front of the vehicle and the color of the graphic 405 has changed to indicate which parts of the vehicle have been adequately captured in the video data. In some embodiments, a third color may be used to indicate which parts of the vehicle the user has already passed but has not been adequately captured in the video data recorded thus far. Thus, the overlay 405 may be updated to indicate which parts of the vehicle have already been adequately captured in the video data, which parts of the vehicle have not been adequately captured in the video data and which parts of the vehicle have not yet been recorded by the user. In some exemplary embodiments, the overlay may indicate that the user should also obtain other video data such as the vehicle's VIN as displayed on the front windshield, or the vehicle's license plate. Optionally, the overlay may indicate when the VIN was able to be read by the device. The user may also be shown an image of the VIN as well as the systems reading of the VIN to confirm that the optical character recognition (OCR) worked properly.

In addition, FIG. 4b shows an example of an alert 450 indicating to the user that the manner in which the video is being recorded should be modified. This alert 450 is described above with regard to 320 of the method 300. In this example, the alert 450 is a request that the user slow down while moving around the vehicle during the recording the video. The alert 450 further explains that moving too fast may cause the video to be blurry. The example overlay 400 and alert 450 are merely provided for illustrative purposes. For instance, in some embodiments, augmented reality (AR) techniques may be used to provide dynamic feedback that is more sophisticated than a two-dimensional graphic. The exemplary embodiments may utilize any appropriate graphic or visual component to provide the user with dynamic feedback that guides the user in recording video and/or collecting data to assess the state of the vehicle.

The application may also obtain data from the user device 100 regarding the height of the camera 120 during the recording of the video. Using a calculation of the height, the application may guide the user to increase or decrease the height of the camera 120 to capture additional information (such as video of the roof, undercarriage, or the lower portion of bumper covers and doors). As indicated above, the video may be analyzed to determine the distance of the camera 120 from the vehicle. Alternatively, this distance can be based on information obtained from a sensor such as, for example, a light detection and ranging (LIDAR) sensor embedded in the user device 100. Information from other types of sensors may also be used to determine the distance, such as ultrasonic, infrared, or LED time-of-flight (ToF). The application could also determine whether the angle of the video should be changed to improve the ability of the application to assess the state of the vehicle. The angle can be adjusted in the vertical plane and/or the horizontal plane to provide e.g., an image perpendicular to the vehicle, an image level with the midpoint of the height of the car but not perpendicular to the side, or an image from an angle above the car.

In some embodiments, the classifying AI may be agnostic with respect to the make and/or model of the vehicle being recorded. Thus, the user may initiate the inspection process and begin capturing video of the vehicle without entering any initial information with respect to the vehicle. The classifying AI may identify any or all of the type of vehicle, the make model, the year, etc. from the video recorded by the user. In alternative embodiments, the class of vehicle, such as sedan, coupe, truck, van, minivan, station wagon, motorcycle, etc., or some other information, might be obtained from the user prior to the recording the video.

In 335, the application determines whether sufficient video data has been collected to assess the state of the vehicle. When more video data is needed to assess the state of the vehicle, the method 300 returns to 310 where one or more segments of video are received by the application.

The examples provided above are described with regard to the user recording video of the exterior of the vehicle. Similar processes may be used to guide the user in recording video of other aspects of the vehicle such as, but not limited to, the interior of the vehicle, under the hood of the vehicle (e.g., the engine, etc.), the undercarriage of the vehicle, inside the trunk, etc. For example, the user may be instructed to record video of the interior of the vehicle, as a separate video or a continuous video with the exterior portions, to video specific interior features such as the driver seat, the odometer, the dashboard, the interior roof, the rear seats, etc. In some exemplary embodiments, these instructions may include wire frame images of the item of interest for the user to position into the camera view.

In some embodiments, the application may prompt the user to acquire additional video or images of certain parts of the vehicle based on conditions identified from the one or more segments of video. For example, if damage to the front of the vehicle is detected, the application may request that the user open the hood and record video or take phots of the engine. As will be described in more detail below, in some embodiments, the application may request that the user collect audio data using the user device 100 while the engine is running to assess a state of the engine. In another example, if damage is identified on one part of the vehicle that is consistent with hail damage, the application may request that the user take additional video of the other parts (e.g., the roof, the side panels, the hood, etc.).

In some embodiments, the application may prompt the user to acquire additional video or images of certain parts of the vehicle if the mileage exceeds a certain threshold value. The mileage may be identified by reading the odometer captured in video or images using machine vision or any other appropriate technique (e.g., OCR, a language processing model, etc.). In such situations, the application may indicate when it has obtained the mileage reading from the image, and may request the user to confirm the accuracy of the reading. Alternatively, the mileage may be manually entered by the user. When the mileage exceeds the threshold value, the application may request additional video or images to evaluate the state of the tires.

When more video data is not needed to assess the state of the vehicle, the method 300 continues to 340. In 340, the application generates an assessment of the state of the vehicle. In some examples, the application may be evaluating the vehicle to produce a damage estimate of the vehicle. In other examples, the application may be evaluating the vehicle to produce an appraisal of the vehicle. In further examples, the application may be evaluating the vehicle to track the state of the vehicle over time. Each of these examples are described in more detail below.

In one aspect, one or more classifiers may assess damage to the exterior of the vehicle. In addition, the one or more classifiers may determine whether a part should be repaired or replaced, and, if repaired, an estimate of the labor hours for the repair.

The one or more classifiers may enable the application to produce a full or partial initial estimate to repair the damage to the vehicle. Alternative assessments may be made, including, for example, a recommendation of whether to file an insurance claim based on an estimated cost value exceeding a threshold cost value, or an analysis of the impact of a claim on future insurance premiums compared to the cost of the repair. An additional assessment may be used to recommend whether the car may be driven in its current state, or whether the damage suffered by the car is sufficiently severe to preclude driving the vehicle prior to repair. When the damage is sufficiently severe, the application may recommend that a towing service be contacted.

In some embodiments, a full or partial estimate may be displayed by the application. These estimates may be based on the output of the classifiers in the application itself, or the estimates may be based on information received from remote classifiers that have also analyzed at least some portion of the data obtained or derived by the application. In some embodiments, the identification of parts, the assessments of damage and repair operations, and a full or partial estimate of the damage can be assessed without information regarding the make, model or year of the vehicle being analyzed.

In other exemplary embodiments, the classifiers may determine that there is the possibility of internal or mechanical damage. In this type of scenario, the user may be prompted to open portions of the vehicle such as the hood, trunk, or doors, to record additional video and evaluate any damage that may be present.

The damage assessment may also include assessments of minor or cosmetic damage. These assessments could be used in non-repair situations, for example, to help in the appraisal of the vehicle. The minor damage assessments may be used, optionally along with other information regarding the vehicle, to determine the overall state of the vehicle. This could be used to determine the value of the car in the resale market, e.g., as a trade in or in a private sale. Alternatively, these assessments may also determine a salvage value of the car by, for example, evaluating the individual values of the vehicle parts for sale as repair parts. These classifiers could determine not only what parts have no damage, but also where there is damage, the expected expense or labor to repair the part.

In a further embodiment, the one or more classifiers may generate a confidence value associated with the assessment of the vehicle. The system may identify parts for which the assessment has a confidence value below a certain level and prompt the user to record additional video of that portion of the vehicle. The dynamic display could indicate what parts of the vehicle currently seen by the camera have an adequate level of confidence. The dynamic display could further indicate which parts of the vehicle have damage assessments with a predetermined level of confidence in images captured earlier in that session. This will enable the user to isolate which parts of the vehicle need to be captured to assess the state of the vehicle.

To the extent that additional information regarding the vehicle is desired to assess the state of the vehicle, this information could be obtained by the application prompting for video or images to be taken of other specific portions of the vehicle such as the interior, an undercarriage, inside the trunk, under the hood, a vehicle identification number (VIN) plate, a license plate, the odometer and other vehicle information provided elsewhere, such as information regarding the vehicle located on the driver's front side door jamb which might include information regarding trim levels, paint colors, manufacturer, model, the VIN, tire information. Sometimes instead of the front door jamb this information is located on the door, the A-pillar, or the glove box.

The assessment of the state of the vehicle may include a paint condition or a surface condition for each part of the vehicle and/or the vehicle as a whole. For example, the one or more classifiers may identify for each part of the vehicle a paint condition. The paint condition may be output as a score or a preset identifier (e.g., faded, flaking, bubbling, scratched, satisfactory, mint, etc.). In addition, the assessment of the state of the vehicle may include a rust condition for each part of the vehicle and/or the vehicle as a whole. For example, the one or more classifiers may identify for each part of the vehicle a severity of corrosion. The rust condition may be output as a score or a preset identifier. In addition, the application may indicate whether the rust can be treated or whether a part needs to be replaced.

The assessment of the state of the vehicle may also include a tire condition for each tire of the vehicle. For example, the one or more classifiers may identify for each tire a severity of wear, weather a portion of a tread of a tire has a tread depth that is below a threshold value. The assessment of the tread of the tire may be used by the application to determine whether a tire needs to be replaced, whether tires should be rotated to even out the wear on the tires or whether an alignment should be performed based on the condition of the tires.

According to some embodiments, the application may also collect audio data generated by the vehicle. For example, the user device 100 may include an audio input device (e.g., a microphone, etc.). The audio input device may listen to the vehicle when it is running and generate audio data. The audio data may be input into one or more classifiers to determine an engine state. For instance, the audio data may indicate that there is damage to one or more components of the engine. To provide one example, if the vehicle is missing a catalytic converter, the engine may produce a loud rumbling sound. One or more classifiers may be trained to identify sounds produced by an engine indicating that there is damage to the engine and/or missing components. Similarly, one or more classifiers may be trained to identify damage and/or missing components to the exhaust system. For example, if the muffler is damaged or missing, the vehicle may produce a much louder sound while the engine is running. Thus, one or more classifiers may be used to identify issues related to the engine and exhaust system based on audio data collected by the user device 100.

In another example, the user device 100 may collect audio data generated by the sound system of the vehicle. This audio data may be input into one or more classifiers to determine a state of the sound system. To provide an example, if a speaker is blown out, wires are loose and/or there is damage to any component of the sound system, the sound system may produce static. Thus, one or more classifiers may be used to identify issues related to sound system based on audio data collected by the user device 100.

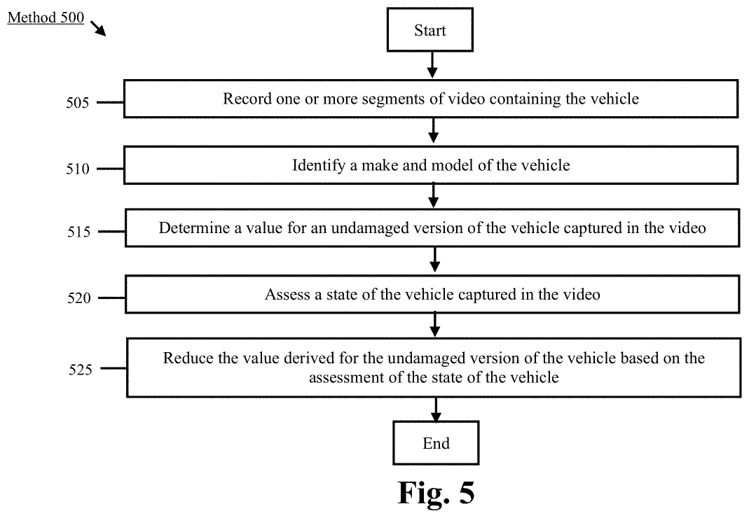

FIG. 5 shows a method 500 for determining a value of an inspected vehicle according to various exemplary embodiments. The method 500 will be described with regard to the method 300 of FIG. 3, the system 200 of FIG. 2 and the user device 100 of FIG. 1.

In 505, the user device 100 records one or more segments of video containing the vehicle. In 510, the application identifies a make and model of the vehicle. The user device 100 may identify these parameters based on the one or more classifiers, information manually entered by the user or by any other appropriate means.

In 515, the application determines a value for an undamaged version of the vehicle captured in the video. This determination may be based on one or more classifiers, existing pricing gradations (e.g., Kelly blue book (KBB), etc.), a look up table stored at the user device 100 or the remote server 210 or any other appropriate resource.

In 520, the application assesses a state of the vehicle captured in the video. The one or more segments of video may be processed in accordance with the examples provided above to the assess the state of the vehicle.

In 525, the application reduces the value derived for the undamaged version vehicle based on the assessment of the state of the vehicle to generate an estimated value (X). For instance, factors such as, but not limited to, the geographical location of the car, the state of the engine, the state of the exhaust system, the state of the sound system, the paint condition, the surface condition, the state of the interior, the presence and severity of damage, and the presence and severity of rust may have an impact on the estimated value of the vehicle.

In some embodiments, instead of or in addition to reducing the value of the undamaged vehicle, the application may produce an estimate of the cost to fix one or more aspects of the vehicle. This may also include an estimate as to how fixing one or more aspects of the vehicle may improve the estimated valuation of the vehicle. To provide one general example, one or more classifiers may identify that the paint on one or more parts is faded, corrosion is located on a side panel and the engine has a damaged or missing component (e.g., catalytic converter). The application may reduce the value derived for the undamaged version vehicle to account for these issues identified from the video capturing the actual vehicle and generate an estimated value (X). In addition, the application may estimate the cost (A) to fix the faded paint, the cost (B) to replace the corroded side panel and the cost (C) to fix the damaged or missing engine component. The application may further estimate that fixing the faded paint may increase the estimated value (X) by a value (Y), replacing the side panel may increase the estimated value (X) by a value of (W) and fixing the damaged or missing engine component may increase the estimated value (X) by a value of (Z). The examples provided above are merely provided for illustrative purposes and are not intended to limit the exemplary embodiments in any way.

The application may generate an inspection report of the vehicle which includes insights generated from the AI, including an assessment of the overall condition of the vehicle (Excellent, Good, Fair, Poor, etc.). In addition, or alternatively, the inspection report may include the total estimated cost to repair or rehabilitate the vehicle to a higher level of condition (e.g., to transform an overall condition of poor to good). Additionally, the report may include a selection of images derived from the video which indicate the overall condition of the car, such as from various preset angles, the VIN, the odometer, tires, interior portions, the engine. The inspection report may provide more detail regarding various portions of the vehicle in need of repair, including the proposed repair operations, and the components of the costs of the repair operations. The report may include images taken from the video which show images which the AI has determined most clearly display the identified damage.

Providing results of the inspection of the vehicle in real-time may entice further user engagement. For example, an online retailer may send an offer to purchase the vehicle from the user via the application with little to no human intervention. The offer may be based on the estimated value (X) and include a time and/or location where the vehicle may be picked up by an agent of the online retailer. The application may allow a user to accept the transaction, and provide information such as banking information for transfer of funds, proof of identity, or other information that will be necessary to complete the sale of the vehicle. The application may request the user to user to provide additional information needed as part of the offer or sale process, such as for example, information regarding existing bank loans, vehicle title and registration information, and repair and maintenance history.

An offer to purchase the vehicle from a user may also be connected to the purchase of a different vehicle by the user. The offer may be independent or contingent upon such a purchase by the user. The application may use information obtained during the vehicle condition assessment to suggest used or new vehicles for purchase by the user, such as vehicles whose purchase price minus the offer price for the user's current vehicle meet the requirements of the user.

In some embodiments, the application may restrict the manner in which the video of the vehicle is recorded by the user to ensure that the vehicle shown in the one or more segments of video is the same vehicle. For example, the application may require the user to record a continuous video that includes an identifier specific to the vehicle (e.g., VIN, license plate, etc.), adequately captures the parts of the vehicle and is of sufficient quality to assess the state of the vehicle. In this scenario, the dynamic feedback may include an alert to the user indicating to the user that a video clip is to include the identifier specific to the vehicle (e.g., VIN, license plate, etc.). This may ensure that the video has not been edited in a manner that may alter the assessment of the vehicle. In another example, if multiple video clips are used, the application may require that each video clip shows a same identifier (e.g., VIN, license plate, etc.). In addition, the application may compare a paint color in a first video clip to a paint color in a second video clip to ensure that the vehicle shown in the first and second video clip are the same vehicle.

The exemplary embodiments may also be used to track the history of the vehicle. For instance, a real-time inspection of the vehicle may be performed using the user device 100 at a first time. The application may output a vehicle signature indicating a state of the vehicle at the first time. The vehicle signature may comprise information such as, but not limited to, type of damage present, location of damage, severity of damage, the state of the engine, the state of the exhaust system, the state of the sound system, the paint condition, the surface condition, the state of the interior and the presence and severity of rust. The vehicle signature may be stored in a secured database such as a decentralized blockchain based database.

As new inspections are performed, the vehicle signature may be updated. For example, a real-time inspection of the vehicle may be performed using the user device 100 at a second time. The vehicle signature may be processed by one or more trained models to identify different types of preventative maintenance that may be performed on the vehicle. In addition, the vehicle signature may provide a transparent history of the vehicle that may be used to appraise the current value of the vehicle.

Those skilled in the art will understand that the above-described exemplary embodiments may be implemented in any suitable software or hardware configuration or combination thereof. An exemplary hardware platform for implementing the exemplary embodiments may include, for example, an Intel based platform with compatible operating system, a Windows OS, a Mac platform and MAC OS, a mobile device having an operating system such as iOS, Android, etc. The exemplary embodiments of the above-described methods may be embodied as software containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method for inspecting a vehicle, comprising:
capturing one or more segments of video of the vehicle comprising a plurality of parts;
identifying, using one or more classifiers, one or more parts of the vehicle captured in the one or more segments of video;
generating feedback related to capturing the one or more segments of video; and
displaying an interface comprising the feedback and video data being captured.

2. The method of claim 1, wherein the feedback includes an overlay comprising a two-dimensional graphical representation configured to indicate which parts of the vehicle have been captured in the one or more segments of video.

3. The method of claim 2, wherein the two-dimensional graphical representation comprises a representation of the vehicle or a representation of a generic vehicle.

4. The method of claim 1, wherein the feedback includes a graphical representation of the vehicle and a progress bar configured to indicate which parts of the vehicle have been captured in the one or more segments of video and a current location of the user device relative to the vehicle.

5. The method of claim 1, wherein the feedback includes an alert configured to indicate a request to a user during the recording of the video to change a distance or angle between the camera and the vehicle.

6. The method of claim 5, wherein the request to change the distance or angle is based on identifying a region of interest on the vehicle.

7. The method of claim 1, wherein the feedback includes an alert configured to indicate a request to a user during the recording of the video to change a manner in which the user is moving the camera.

8. The method of claim 1, the processor configured to perform operations further comprising:
assessing, using the one or more classifiers, a state of the vehicle.

9. The method of claim 8, wherein the state of the vehicle provides the basis for an estimated evaluation of the vehicle.

10. The method of claim 8, wherein the state of the vehicle comprises a paint condition for one or more parts of the vehicle.

11. The method of claim 1, further comprising:
capturing audio data of the vehicle in operation; and
assessing, using the one or more classifiers, a state of the vehicle based on the audio data.

12. The method of claim 1, the processor configured to perform operations further comprising:
generating a request to the user to collect image data or video data of the vehicle after a first video clip is recorded of the vehicle at the user device based on the one or more segments of video.

13. The method of claim 1, wherein the feedback includes an indication to the user that a video clip being recorded by the user is to include an identifier specific to the vehicle.

14. A computer program product for inspecting a vehicle comprising computer code to:
capture one or more segments of video of the vehicle comprising a plurality of parts;
identify, using one or more classifiers, one or more parts of the vehicle captured in the one or more segments of video;
generate feedback related to capturing the one or more segments of video; and
display an interface comprising the feedback and video data being captured.

15. The computer program product of claim 14, wherein the feedback includes an overlay comprising a two-dimensional graphical representation configured to indicate which parts of the vehicle have been captured in the one or more segments of video, wherein the two-dimensional graphical representation comprises a representation of the vehicle or a representation of a generic vehicle.

16. The computer program product of claim 14, wherein the feedback includes a graphical representation of the vehicle and a progress bar configured to indicate which parts of the vehicle have been captured in the one or more segments of video and a current location of the user device relative to the vehicle.

17. The computer program product of claim 14, wherein the feedback includes an alert configured to indicate a request to a user during the recording of the video to change a distance or angle between the camera and the vehicle.

18. The computer program product of claim 14, wherein the feedback includes an alert configured to indicate a request to a user during the recording of the video to change a manner in which the user is moving the camera.

19. The computer program product of claim 14, further comprising computer code to:
assess, using the one or more classifiers, a state of the vehicle, wherein the state of the vehicle provides the basis for an estimated evaluation of the vehicle.

20. The computer program product of claim 14, further comprising computer code to:
generate a request to the user to collect image data or video data of the vehicle after a first video clip is recorded of the vehicle at the user device based on the one or more segments of video.
